(19) United States
(12) Patent Application Publication
(10) Pub. No.: US 2007/0299618 A1
(43) Pub. Date: Dec. 27, 2007

(54) Microarray Method

(76) Inventor: Natan Dotan, Chicago, IL (US)

Correspondence Address: Natan Dotan, 4845 S. Ellis Ave., Chicago, IL, 60615, US

(21) Appl. No.: 11/460,969

(22) Filed: Jul. 28, 2006

Related U.S. Application Data
(63) Continuation-in-part of application No. 11/473,472, filed on Jun. 24, 2006, now abandoned.

(51) Int. Cl. G06F 19/00

(52) U.S. Cl. 702/20

(57) ABSTRACT

A method for correcting microarray data for the effects of cross-hybridization comprising multiplication of microarray probe hybridization intensities with the inverse or pseudoinverse of a matrix of cross-hybridization potentials between probes and targets. This matrix of cross-hybridization potentials may be determined experimentally by repeating a microarray experiment with each of the targeted genes individually present to determine the cross-hybridization of that targeted gene to each probe, or alternatively, computational models of hybridization may be employed. This represents a new paradigm for handling the problem of cross-hybridization and also can be used in probe-set design strategies.

### CROSS-REFERENCE TO RELATED APPLICATIONS

This is a continuation-in-part of application Ser. No. 11/473,472, Filed Jun. 24, 2006.

### FEDERALLY SPONSORED RESEARCH Not Applicable

### SEQUENCE LISTING OR PROGRAM

Not Applicable

### BACKGROUND OF THE INVENTION

1. Field of the Invention

This invention relates to DNA microarrays. More specifically this invention relates to a method of manipulating the data produced by such microarrays. The methods of the present invention are also applicable to the analysis of other nucleotide-nucleotide interactions as well as all nucleic acid-nucleic acid, DNA-protein, RNA-protein, and protein-protein interactions.

2. Description of Prior Art

DNA microarrays are known in which genetic probes are affixed to a substrate at discrete locations for binding with a sample containing labeled genetic material. Terminologies used to describe this technology include biochip, DNA chip, DNA microarray and gene array. DNA microarrays allow massively parallel gene expression studies.

In one type of study employing DNA microarrays the genetic composition of one or more samples is investigated. In the case of samples containing messenger RNA, for instance, a microarray is provided to have a set of cDNA spots for binding. These cDNA spots are referred to as probes. Messenger RNA polynucleotides in the samples being investigated that are complementary to these cDNA probes hybridize with said probes. After hybridization has occurred images of the microarray are obtained using a laser scanner designed to induce fluorescence in markers previously bound to the sample mRNA. In the resulting image the genetic composition of the sample investigated is indicated by the measured intensities of probe locations on the microarray. Such microarray experiments have found a broad range of uses especially in comparative studies between diseased and healthy organisms.

DNA microarrays, while providing a wealth of data from a massively parallel design, are prone to distortions of various kinds. In many assays there may be one or more nucleic acids present that have a nucleotide sequence closely related to that of one or more of the target sequences being investigated and that differ by only a few nucleotides (one to five for example). In such cases the non-target nucleic acid or nucleic acids may then interfere with the assay by hybridizing with at least some of the probes to produce false qualitative or quantitative results. This problem is particularly acute where the probe sequence is selected to permit assaying of various genes within a multigene family, each member of which contains a sequence closely related to another target nucleotide sequence.

Thus, in analysis by array technology there is the concern that cross-hybridization may occur—i.e., hybridization of certain sample polynucleotides to probes designed to measure other sample polynucleotides. This could result in false positive signals. This is especially relevant in the field of immunology for example where antibody genes that have high degrees of homology between them are often the subjects of investigation. An effective means of disambiguating intended hybridization and cross-hybridization in such microarrays of high-homology genes would prove highly useful both in research and also in medical diagnostics. This is especially the case for diagnostics relating to autoimmune diseases. Autoimmune diseases such as systemic lupus erythematosus, for instance, are often idiosyncratic in terms of the specific auto-antibody repertoire expressed. For such diseases, as well as for many others, detailed knowledge of the patient-specific manifestation of the disease can valuably inform treatment strategies. An effective array of highly homologous antibody genes could be part of an efficient means to detect the patient-specific auto-antibody repertoire that characterizes a given disease state.

Approaches have been suggested for alleviating some of the above concerns of specificity and cross-hybridization. One technique involves placing on an array control probes intentionally mismatched with respect to the targets under investigation as well as probes targeting with perfect complementarity the target segments of interest. A mismatched probe differs from a fully complementary probe in that it has one or more base substitutions. By comparing the hybridization signal for the original probe with that of the mismatched probes it is assumed that one can gauge specificity and perhaps even correct for cross-hybridization by subtracting some fraction of the mismatch probe signal from the signal generated by the probe of interest.

There are some shortcomings to this approach. While the difference between matched and mismatched probes tracks target concentration fairly well when hybridizing to the intended target there is evidence that this correspondence is poorly defined for cases of cross-hybridization (Wu et. al.). This flaw has lead some investigations to the conclusion that it is better to ignore the mismatched probes altogether in estimations of gene expression (Wu et. al.).

Another approach to resolving the problem of cross-hybridization involves the design and use of cross-hybridizing probes to identify cross-hybridization events. This approach is outlined in U.S. Pat. No. 6,461,816. These cross-hybridizing probes are meant to identify “cross-hybridization events” of a “predetermined probability” to identify the effect of “interfering” targets. This means including additional probes in a microarray experiment to target genes that may cross-hybridize to the original intended probe set. The claimed use of the data gathered from these cross-hybridizing probes is for “selecting or rejecting” a given probe based on its determined risk for distortion due to interference by cross-hybridizing targets. This method recognizes the possibility that untargeted genes in an experimental sample could hybridize to probes targeting other sample genes. It does not though solve the problems of dealing with a large number of highly homologous, potentially cross-hybridizing, targets of interest. It is specified that if a high probability of cross-hybridization is identified, “then the probe is not specific and should not be used without using the results of the cross-hybridization target experiment to correct for cross-hybridization.” This method amounts to an analysis of the specificity of a probe, and though it suggests when correction for cross-hybridization may be necessary, no way of effectively achieving this is specified.

There are additional methods in the prior art for determining specificity and relative potentials for cross-hybridization of probe and target sets. These include comparing the free-energies of hybridization for gene-specific or cross-hybridizing targets or probes. Computational methods for estimating the free-energy of polynucleotide annealing such as the models of Zucker based on the nucleotide nearest-neighbor thermodynamic studies of SantaLucia are known in the prior art (Rouillard, et. al, 2003; SantaLucia, J, Jr. 1998). Additionally U.S. Pat. No. 6,551,784 discloses a neural network method of predicting hybridization and cross-hybridization intensities in order to chose probes with the least cross-hybridization potential.

Still other methods have been disclosed for determining the cross-hybridization potential of a set of polymers (DNA, RNA, or Polypeptides). U.S. Pat. No. 6,403,314 discloses one such method in which a matrix of all possible interactions is created and analyzed to identify appropriate probe/target combinations that minimize cross-hybridization within the probe set. This method relies on methods of scoring cross-hybridization potential including thermodynamic calculations. Rouillard, et. al. also describe the use of a matrix to keep a record of “all similarities between the current oligonucleotide sequence and other sequences.” These similarities are used to compute thermodynamic values to distinguish probes with minimal or no cross-hybridization potential.

While methods have been disclosed in the prior art for identifying potentially cross-hybridizing probes, there remains a need for a method of quantitatively and reliably distinguishing the contributions of cross-hybridization and intended hybridization in the data produced by microarray experiments. This is especially the case in microarray experiments that seek to investigate highly homologous genes. The methods for resolving problems of cross-hybridization that dominate the prior art are generally dominated by efforts to minimize the occurrence of cross-hybridization by choosing probes that target maximally characteristic segments of targets—those with least homology to regions in other targets. While this remains important, a method for distinguishing highly homologous targets has been wanting due to the effects of cross-hybridization. Nevertheless there remains great potential utility for such a method especially in the fields of research and medical diagnostics.

Therefore, in light of the severe shortcomings of previous approaches towards resolving the problem of cross-hybridization in microarray experiments, the method of this invention is disclosed.

3. Objects and Advantages

Thus, the objects of the invention of the microarray analysis method disclosed herein are:
(a) to provide a method for correcting microarray data for the effect of cross-hybridization;
(b) to provide a method for analyzing microarray data that will allow clear results to be obtained in experiments comparing highly homologous sequences;
(c) to further provide such a method that can yield quantitative results;

Further objects and advantages will become apparent from a consideration of the following descriptions and drawings.

### SUMMARY OF THE INVENTION

Briefly, these and other objects of my invention are achieved by the use of a matrix to represent the cross-hybridization potential of each target to every probe, the inverse or pseudoinverse of which matrix is then determined and a vector of experimental results is multiplied by this inverse or pseudoinverse matrix to yield a resultant vector in which the effect of cross-hybridization has been mitigated. This matrix of cross-hybridization potentials may be determined experimentally by repeating a microarray experiment with each of the targets individually present to determine the cross-hybridization of that targeted gene to each probe, or alternatively, computational models of hybridization may be employed. This represents a new paradigm for handling the problem of cross-hybridization and also can be used in probe-set design strategies.

### DRAWINGS—FIGURES

FIG. 1 is a schematic illustration of the interaction between a set of targets and a single probe.

FIG. 2 is a schematic illustration of the interaction between a set of targets and a single probe including a vector representative of interaction potentials.

FIG. 3 is an illustration of the multiplication of two vectors.

FIG. 4 is a schematic illustration of the interaction between a set of targets and a set of probes.

FIG. 5 is an illustration of an example of a matrix generated from hybridization and cross-hybridization potentials.

FIG. 6 is an illustration of the multiplication of a vector of target concentrations and a matrix of hybridization potentials to yield a vector of hybridization intensities.

FIG. 7 is an illustration of the multiplication of a vector of target concentrations and a matrix of hybridization potentials to yield a vector of hybridization intensities in which illustration the number of probes is less than the number of targets.

FIG. 8 is an illustration of the multiplication of a vector of target concentrations and a matrix of hybridization potentials to yield a vector of hybridization intensities in which illustration the number of probes exceeds the number of targets.

### DRAWINGS—REFERENCE NUMERALS

10 probe

15 set of five probes

20 lines representing hybridization potential between each target and a single probe

25 column vector of values representing hybridization potential between each target and a single probe

27 lines representing hybridization potentials between each target and each probe

30 target maximally complementary to probe 10

35 vector of target concentrations in experimental sample

37 vector of target concentrations in experimental sample

38 total hybridization intensity at probe 10

40 set of targets which may hybridize to probe 10 but which are not maximally complementary to probe 10

45 set of targets each matched to a probe in the set of probes 15

50 vector of values representing hybridization potentials between each target in 45 and first probe in 15

52 vector of values representing hybridization potentials between each target in 45 and second probe in 15

54 vector of values representing hybridization potentials between each target in 45 and third probe in 15

56 vector of values representing hybridization potentials between each target in 45 and fourth probe in 15

58 vector of values representing hybridization potentials between each target in 45 and fifth probe in 15

60 the matrix composed of vectors 50, 52, 54, 56, and 58

65 the non-square matrix composed of vectors 50, 52, 54, and 56

67 the non-square matrix composed of the first four rows of matrix 60

70 vector of overall hybridization intensities at each probe

75 vector of overall hybridization intensities at each probe

77 vector of overall hybridization intensities at each probe

### DETAILED DESCRIPTION

In the following description, the invention is described in connection with a preferred embodiment. References are made to accompanying figures. Values used are for purely illustrative purposes and are not representative of any limiting implementation.

Terminology has been a contentious issue in the prior art. The following terminology will be used in the descriptions that follow.

“Target” shall refer to the polynucleotide or other sample molecule of interest being investigated in a given experiment. For instance an experiment may include investigating a messenger RNA sample taken from an experimental organism in order to identify the levels of target polynucleotide present in said sample.

“Probe” shall refer to a known polynucleotide fragment or other known molecule used to investigate a target. In an example experiment investigating mRNA for instance the probes would constitute the various polynucleotide fragments immobilized on a solid support.

“Microarray” shall refer to the tool comprised of a spatially organized collection of probes and the solid support on which these are immobilized.

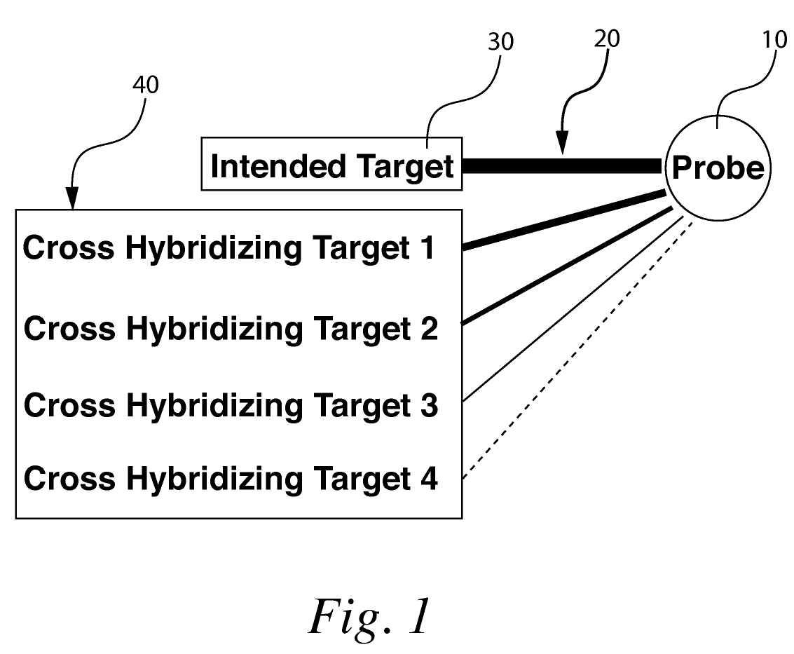

FIG. 1 is a schematic representation of the interaction between a set of target polynucleotides 30 and 40, and a probe 10. The relative interaction strength between probe 10 and each of the target polynucleotides in the set of targets 30 and 40 is represented by the collection of lines 20 connecting the target polynucleotides 30 and 40, and the probe 10. In this schematic representation the thickness of each line in the group of lines 20 is related to the magnitude of the hybridization potential that line represents. Broken lines in the set of lines 20 represent zero hybridization potential. In one possible experiment target polynucleotides 30 and 40 represent a potential set of polynucleotides which may be present in a sample being investigated. These target polynucleotides can be messenger RNAs for example, and probe 10 can represent a known cDNA fragment immobilized on a microarray chip as described in Lockhardt, et. al.

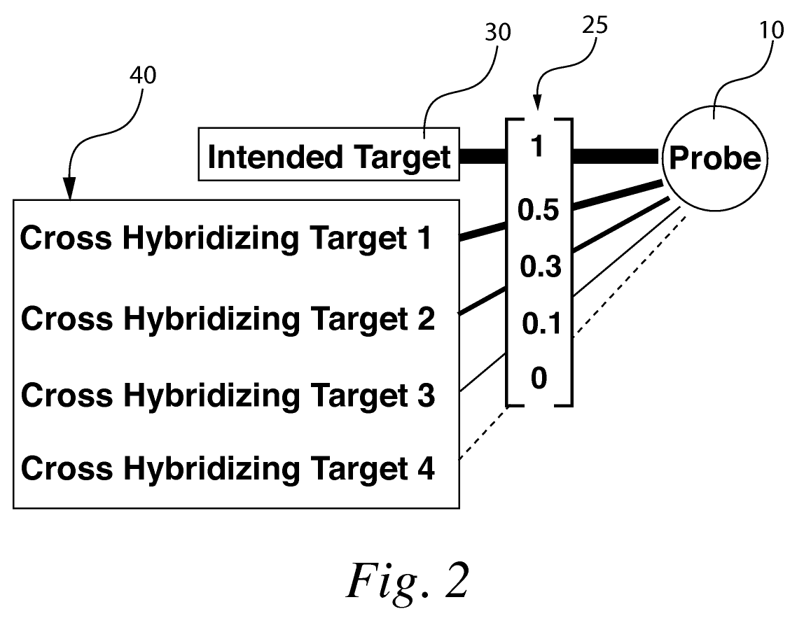

FIG. 2 is a schematic representation similar to FIG. 1. In FIG. 2 the relative hybridization potential between the polynucleotide targets 30 and 40, and probe 10 are represented as a collection of values—i.e. vector 25—superimposed upon the set of lines 20 representing hybridization potentials.

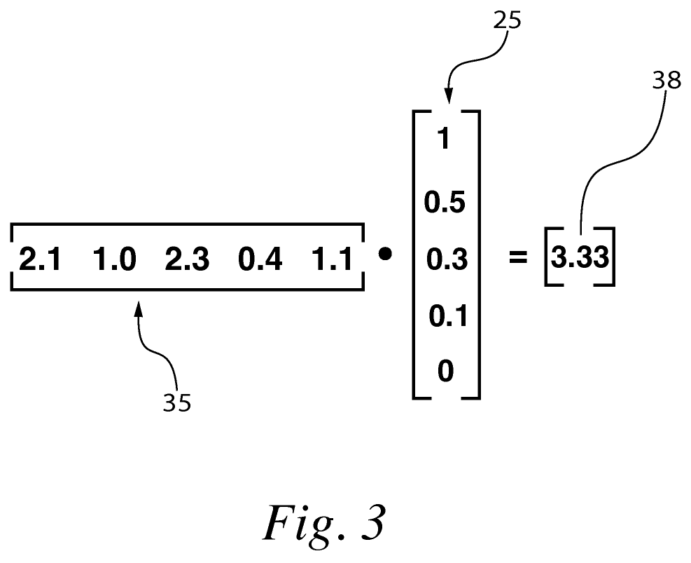

The invention disclosed herein recognizes the fact that the hybridization intensity observed on probe 10 in the example experiment described, and on potentially any probe in an actual experiment, is representative not only of the target 30 for which probe 10 is intended but also of other cross hybridizing targets 40 to varying degrees; the degree to which a cross-hybridizing target is represented in the overall hybridization intensity of a given probe being proportional to the hybridization potential between said target and said probe. Thus the signal that would be observed in a hypothetical experiment at probe 10 can be represented as the dot product of a vector 35 representing the concentrations of each target present in the experimental sample and a vector 25 representing the cross hybridization potential of each of these targets to probe 10. This holds for potentially any probe in any microarray experiment, especially those subject to cross-hybridization. This amounts to taking the sum across all targets of the product of target concentration and the hybridization potential of that target for a given probe. This multiplication is illustrated in FIG. 3.

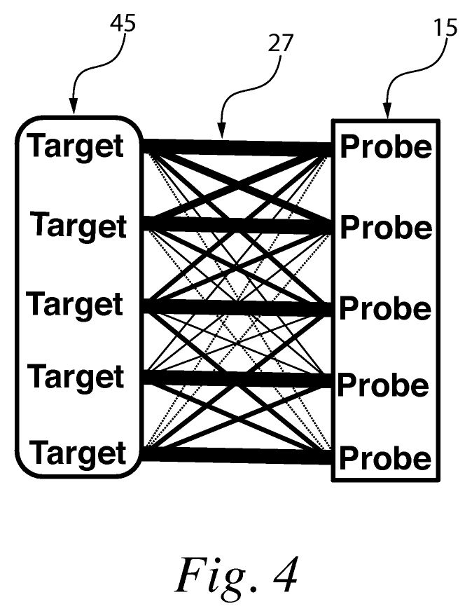

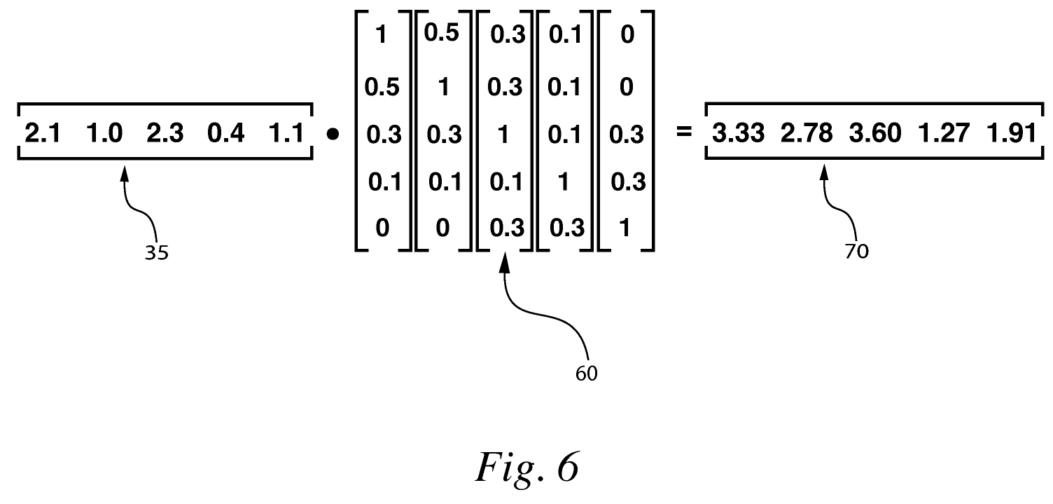

A more complete example of a microarray experiment incorporates multiple probes—often one or more probes for each intended target though it may also be the case that fewer probes are used than the number targets. FIG. 4 shows a schematic illustration similar to FIG. 2. In FIG. 4 each of the targets in the set of targets 45 is designed to hybridize most strongly, or when possible exclusively, with one of the probes in the set of probes 15. As in FIG. 2 the cross hybridization potentials between each target and each probe are represented by lines of varying thicknesses 27 with broken lines representing zero hybridization potential. Thus just as the schematic representation of FIG. 2 is analogous to the matrix multiplication operation of FIG. 3, the schematic of FIG. 4 can be represented as a matrix multiplication operation illustrated in FIG. 6.

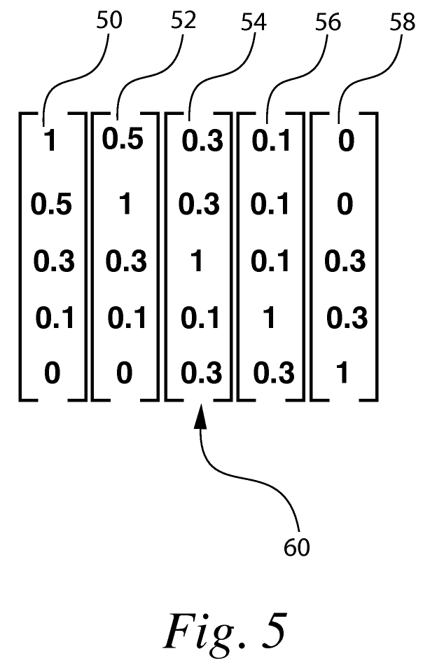

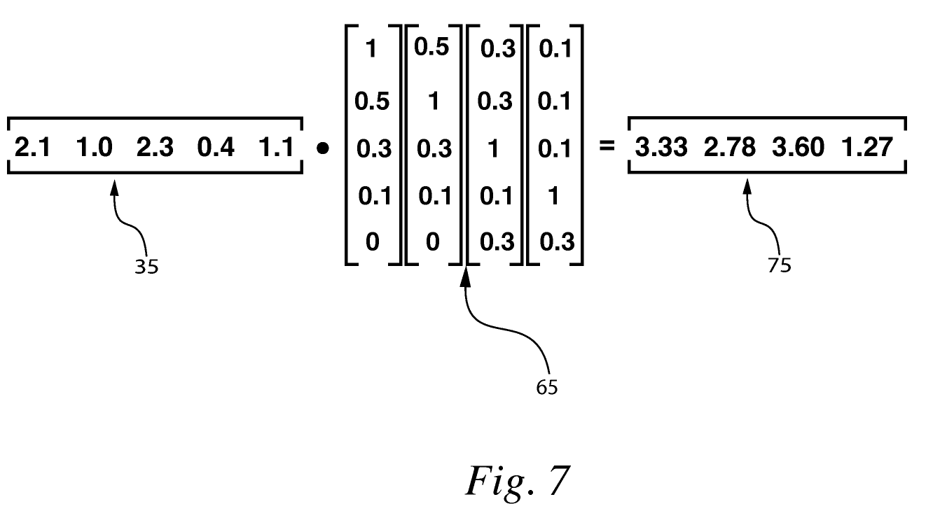

In FIG. 6, the matrix 60, like the vector 25 in FIG. 3, represents the cross hybridization potentials of each target for each given probe. Matrix 60 is made up of five vectors 50, 52, 54, 56, and 58, as shown in FIG. 5. Each of these column vectors represents the hybridization potential of each target in the set of targets 45 for one probe in the set of probes 15. The number of elements in each column vector in the matrix 60 is therefore equal to the number of targets in the experiment. This can represent a situation in which each target is assigned one probe. Other situations also occur though, involving an unequal number of targets and probes. One such situation is described in conjunction with FIG. 7 below. In these cases a non-square matrix of hybridization potentials is generated.

In FIG. 6, vector 70 represents the overall hybridization intensities that are expected at each probe. These overall hybridization intensities incorporate the contribution of the target for which each specific probe is intended as well as the cross hybridizing targets to varying degrees proportional to their cross hybridization potentials represented in matrix 60.

FIG. 7 shows a similar situation to FIG. 6, though FIG. 7 illustrates a situation in which the number of probes is less than the number of targets.

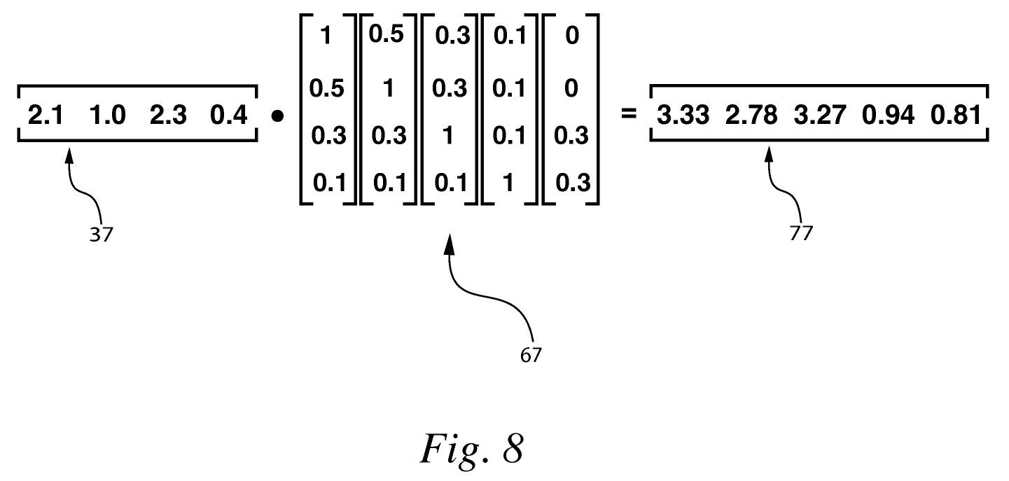

FIG. 8 shows a situation similar to FIG. 6, though FIG. 8 illustrates a situation in which the number of probes exceeds the number of targets.

The invention disclosed herein recognizes in this representation the potential for the resolution of cross-hybridization in a microarray experiment—i.e. mitigating or removing from the measured hybridization intensity at each probe the contribution of cross-hybridizing targets. It is one object of the invention disclosed herein to calculate indicators of original target concentrations when presented with experimental results in which a measured hybridization intensity at each probe represents the combined contributions of intended target and cross-hybridizing targets. The matrix multiplication of FIG. 6, FIG. 7, or FIG. 8 can be represented by equation 1, in which I represents the row vector of original target concentrations present in the experimental sample (i.e. vector 35 in FIG. 6 and FIG. 7, and vector 37 in FIG. 8), C represents the matrix with a number of rows equal to the number of elements in I (i.e. matrix 60 in FIG. 6, matrix 65 in FIG. 7, and matrix 67 in FIG. 8), and O represents the row vector with the same number of elements as columns in C and which represents the overall hybridization intensities at probes on the microarray (i.e. vector 70 in FIG. 6, vector 75 in FIG. 7, and vector 77 in FIG. 8).

I*C=O (Equation 1)

It is an objective of the invention disclosed herein to recover the vector I when presented with the vector O. The matrix C can be determined in multiple ways, discussed below. Once C is known its inverse or pseudoinverse may be calculated using methods known in the prior art. When the vector O and the inverse or pseudoinverse of the matrix C are known, I can be determined by equation 2, in which Ĉ-1 represents the inverse or pseudoinverse of the matrix C. In the preferred embodiment Ĉ-1 represents the inverse of C when C is an invertible matrix and the pseudoinverse of the matrix C when only the psuedoinverse of the matrix C can be determined.

I=O*Ĉ-1 (Equation 2)

The effect of the multiplication of O and Ĉ-1 is further clarified by equation 3. Equation 3 reflects the substitution of O in equation 2 by the product of I and C described in equation 1.

I=I*C*Ĉ-1 (Equation 3)

While not wishing to be bound by theory, it is therefore believed that the vector I can be determined as described in equation 2, so long as Ĉ-1 is chosen such that it satisfies equation 3. As described above the inverse and pseudoinverse of C can be suitable choices.

Thus, a method has been disclosed herein for determining indicators of the concentrations of a set of targets present in an experimental sample from a set of probe hybridization intensities and a matrix describing the hybridization potentials of each target for each probe. Thus, the resolution of intended hybridization and cross-hybridization in microarray experiment data can be accomplished.

The invention disclosed herein makes use of a matrix of hybridization potentials between each target and each probe. This matrix should be determined for each microarray involving new probe/target combinations. Once this matrix has been determined it can be used repeatedly as long as the design of the experiment does not change. This is highly useful in cases where microarrays are used in medical diagnostics. In medical diagnostics there is often much repetition of the same experiments under near identical conditions. For instance, the same matrix may be used for performing the same microarray test on many different individual patients.

In the preferred embodiment, the matrix of hybridization potentials is determined in the following manner. A microarray is allowed to hybridize with a single target only. The hybridization intensity at each probe is measured. These hybridization intensities are scaled. One method of scaling involves dividing the intensity at each probe by the sum of the intensities at all of the probes. These scaled hybridization intensities may then be used as the hybridization potentials of a target polynucleotide for each probe on the microarray. These values occupy a row vector in the matrix of hybridization potentials (e.g. matrix 60, matrix 65, or matrix 67). This is then repeated for all of the targets included in the experiment or some subset thereof until the desired matrix is generated.

An alternative or adjunct method for determining the matrix of hybridization potentials is to use a computational method to determine relative free energies of hybridization of each target for each probe. These free energies of hybridization can then be scaled in a similar manner to that described above to yield a matrix of relative hybridization potentials (e.g. matrix 60, matrix 65, or matrix 67).

### Conclusion, Ramifications, and Scope

Accordingly, the reader will see that the method of this invention can aid in the resolution of cross-hybridization and intended hybridization in microarray experiment data.

Although the description above contains many specificities, these should not be construed as limiting the scope of the invention but as merely providing illustrations of some of the presently preferred embodiments of this invention. For instance, as described above, the invention disclosed herein functions equally well in cases where multiple probes are designed for each target and in cases where there are fewer probes than targets because effective methods of determining the inverse of a given matrix are known as are methods for determining the pseudoinverse of a given matrix. Thus, the scope of this invention should not be limited by the dimensions of the matrix of cross-hybridization potentials used. A possible ramification involves performing the method of the invention disclosed herein on one or more subsets of microarray data. This may be used to facilitate efficient manipulation of data in such cases, for example, where a large number of probes is used but only limited subsets of these are sufficiently homologous to require resolution of cross-hybridization. Additionally a wide variety of methods for determining the inverse of a matrix may be implemented. Also, subsets of a microarray can be examined independently in order to ensure that the matrix of hybridization potentials used can be inverted or its pseudoinverse taken using favored means. Furthermore, as is common in the prior art, methods may be included to relate hybridization intensities (e.g. vectors 35 and 37 described by equation 2 above) from a microarray experiment to actual target concentrations. This can be accomplished for instance by the use of a control target added to the experimental sample and whose concentration in the experimental sample is known. Additionally, although the illustrations in the above descriptions involve between four and five probes and between four and five targets many fold greater are routinely used in microarray experiments. The invention disclosed herein may be used with all numbers of probes and targets. Furthermore, the implementations and scale of the invention may be varied and other modifications and variations made without affecting the spirit or scope of the invention. Thus the scope of the invention should be determined by the appended claims and their legal equivalents, rather than by the examples given.

I claim:

1. A method for adjusting microarray experiment data including the steps: a) determining a first matrix of hybridization potentials between one or more probes and one or more targets, b) determining a second matrix such that multiplying a vector and said first matrix and said second matrix yields said vector, c) multiplying a vector composed of values representing hybridization intensities measured at one or more probes on a microarray with said second matrix; whereby the effect of cross-hybridization on microarray experiment data is mitigated.

2. The method of claim 1 in which said second matrix is the inverse of said first matrix.

3. The method of claim 1 in which said second matrix is the pseudoinverse of said first matrix.

4. The method of claim 1 further including a means for relating hybridization intensities measured at said one or more probes to concentrations of targets in the experimental sample used.

5. The method of claim 1 further including a means for relating the values generated by performing the steps (a), (b), and (c) of claim 1 to concentrations of targets in the experimental sample used.

6. The method of claim 1 applied to one or more subsets of the probes of a microarray experiment.

7. The method of claim 1 applied to one or more subsets of the targets of a microarray experiment.

8. The method of claim 1 in which said probes are polynucleotides.

9. The method of claim 1 in which said probes are antibodies or fragments of antibodies.

10. The method of claim 1 in which said targets are polynucleotides.

11. The method of claim 1 in which said targets are peptides or polypeptides.

12. The method of claim 1 in which said probes are peptides or polypeptides.

13. The method of claim 1 in which said first matrix of hybridization potentials is determined by repeating a microarray experiment and each time using as an experimental sample only a single target whereby the relative hybridization potential of said single target can be determined for one or more probes.

14. The method of claim 1 in which said first matrix of hybridization potentials is determined by repeating a microarray experiment and each time using as an experimental sample only a single target and taking as the hybridization potential between said single target and each probe the result of dividing the hybridization intensity at each probe by the sum of the hybridization intensities at all probes, whereby the relative hybridization potential of said single target can be determined for one or more probes.

15. The method of claim 1 in which said first matrix of hybridization potentials is determined by repeating calculations to determine the relative free energy of hybridization between said one or more targets and said one or more probes.

16. The method of claim 1 in which said first matrix of hybridization potentials is determined by repeating calculations to determine the relative degree to which various probe and target combinations are complementary.

17. The method of claim 1 in which said first matrix of hybridization potentials is determined by performing thermodynamic calculations to determine the relative free energy of hybridization between said one or more targets and said one or more probes.

18. A method for sensing target molecules comprising: a) providing a plurality of probes bound to a solid surface, at least some of said plurality of probes having some degree of complementarity to some set of said target molecules, b) contacting said probes with a collection of target molecules, c) detecting the binding of said target molecules to said probes, d) determining a first matrix of hybridization potentials between one or more of said probes and one or more of said targets, e) determining a second matrix such that multiplying a vector and said first matrix and said second matrix yields said vector, f) multiplying a vector composed of values representing the degree of said binding detected at each of said probes with said second matrix; thereby sensing the degree of presence of said target molecules.

19. A system for sensing target molecules comprising: a) a plurality of probes bound to a solid surface, at least some of said plurality of probes having some degree of complementarity to some set of target molecules, b) a means of contacting the probes with a collection of target molecules, c) a means of detecting the binding of said target molecules to the probes, d) a means of determining a first matrix of hybridization potentials between one or more of said probes and one or more of said target molecules, e) a computational means for determining a second matrix such that multiplying a vector and said first matrix and said second matrix yields said vector, f) a computational means for multiplying a vector composed of values representing the degree of binding detected at one or more of said probes with said second matrix; thereby a system is established for sensing the degree of presence of said target molecules.
